(19) United States
(12) Patent Application Publication
(10) Pub. No.: US 2018/0150902 A1
(43) Pub. Date: May 31, 2018

(54) Systems and Methods for Use in Facilitating Purchase Transactions With Trusted Merchants

(71) Applicant: MASTERCARD INTERNATIONAL INCORPORATED, Purchase, NY (US)

(72) Inventors: Rick Unnerstall, O'Fallon, MO (US); Brian Williams, St. Peters, MO (US); Corey M. Hively, O'Fallon, MO (US); Linda M. Mautz, O'Fallon, MO (US); Mahesh Nagure, O'Fallon, MO (US)

(21) Appl. No.: 15/364,611

(22) Filed: Nov. 30, 2016

(51) Int. Cl. G06Q 30/06; G06Q 20/40; G06Q 20/38

(52) U.S. Cl. CPC G06Q 30/0637; G06Q 20/3821; G06Q 20/40145; G06Q 20/405

(57) ABSTRACT

Systems and methods are provided for use in facilitating payment account transactions. One exemplary method includes receiving, at a computing device, a biometric from a consumer and matching, by the computing device, the biometric to a merchant included in a data structure, where the merchant is associated with a product catalog including products offered for sale by the merchant. The method also includes returning, by the computing device, in response to the biometric, the product catalog to the consumer, and receiving a selection of a product therein from the consumer. The method then further includes facilitating a purchase transaction for the selected product and transmitting, by the computing device, a transaction confirmation for the purchase transaction to the consumer and/or the merchant, whereby the merchant is able to confirm the purchase transaction via the transaction confirmation and deliver the selected product to the consumer.

### FIELD

The present disclosure generally relates to systems and methods for use in facilitating purchase transactions with trusted merchants and, in particular, to systems and methods for use in matching biometrics for representatives of merchants to the merchants, to thereby confirm the representatives (and indicate that the merchants are trusted), and then potentially facilitating purchase transactions with the trusted merchants through payment accounts.

### BACKGROUND

This section provides background information related to the present disclosure which is not necessarily prior art.

Consumers are known to use payment accounts to purchase various different products (e.g., good and services, etc.) from merchants. The merchants may be situated at physical locations, including permanent physical locations (e.g., brick-and-mortar locations, etc.) and/or temporary physical locations (e.g., kiosks, etc.), and/or may be located at virtual locations (e.g., websites, etc.). In any case, in order to initiate purchase transactions with the merchants, consumers often provide payment account information (e.g., primary account numbers (PANs), expiration dates, card verification codes (CVCs), or payment account tokens, etc.) to the merchants, who in turn process the payment account information to facilitate the purchase transactions. In so doing, the merchants possess and/or retain the payment account information and further often take security precautions to inhibit theft and/or unauthorized access to the payment account information by unauthorized or unintended individuals (at the merchant locations or apart therefrom).

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in facilitating a purchase transaction by a consumer at a merchant identified as trusted based on biometric verification of a representative associated with the merchant;

FIG. 2 is a block diagram of a computing device that may be used in the exemplary system of FIG. 1; and

FIG. 3 is an exemplary method, which may be implemented in the system of FIG. 1, for facilitating the purchase transaction between the consumer and the trusted merchant via a payment account associated with the consumer.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Products (e.g., goods and/or services, etc.) are often purchased by consumers from merchants in purchase transactions through use of payment accounts. As such, when the consumers purchase the products, they typically present payment account information to the merchants (or to representatives associated with the merchants) to facilitate funding of the transactions. Depending on the merchants, however, and their locations, sizes, and other characteristics, the consumers may be uneasy or apprehensive about divulging such payment account information to the merchants (and/or to their representatives). Uniquely, the systems and methods herein permit merchants, and specifically the merchants' representatives, to be identified by consumers, through use of biometrics, prior to performing such purchase transactions. For example, when initiating a transaction with a merchant for a product, a consumer initially captures a biometric (e.g., a facial image, a fingerprint, etc.) from a representative of the merchant and submits the biometric to a verification engine, which in turn compares the biometric to a reference biometric (or multiple reference biometrics) for the merchant (and the merchant's representative). When a match is found, the verification engine returns a verification to the consumer of the merchant representative, via an application or other network-based interface associated with the consumer. The consumer may then be permitted to proceed in the purchase of the product and/or to continue to shop at the merchant, through the interface, and then later purchase the product (or another product) through the verification engine (via a payment account associated with the consumer). After the purchase is completed, and following confirmation of the purchase transaction, the merchant is able to deliver the purchased product (or products) to the consumer.

In this manner, prior to purchasing the product(s) or presenting payment account information, for example, the consumer is able to verify the merchant based on the biometric, thereby providing assurances to the consumer that the purchase interaction is with a trusted merchant and thus providing a heightened comfort to the consumer in providing payment account information to the merchant to purchase the product(s). In addition, in various implementations, the consumer may be permitted to facilitate the purchase transaction with the merchant without actually divulging his/her payment account information to the merchant representative (e.g., the consumer purchases the product through, or by aid of, the verification engine, etc.). As such, the purchase transactions by the consumer, when involving an unknown or unfamiliar merchant (or merchant representative) (or even a known and familiar merchant), may be more efficient and/or secure for the merchant, while also appearing to be (and potentially being) less risky for the consumer.

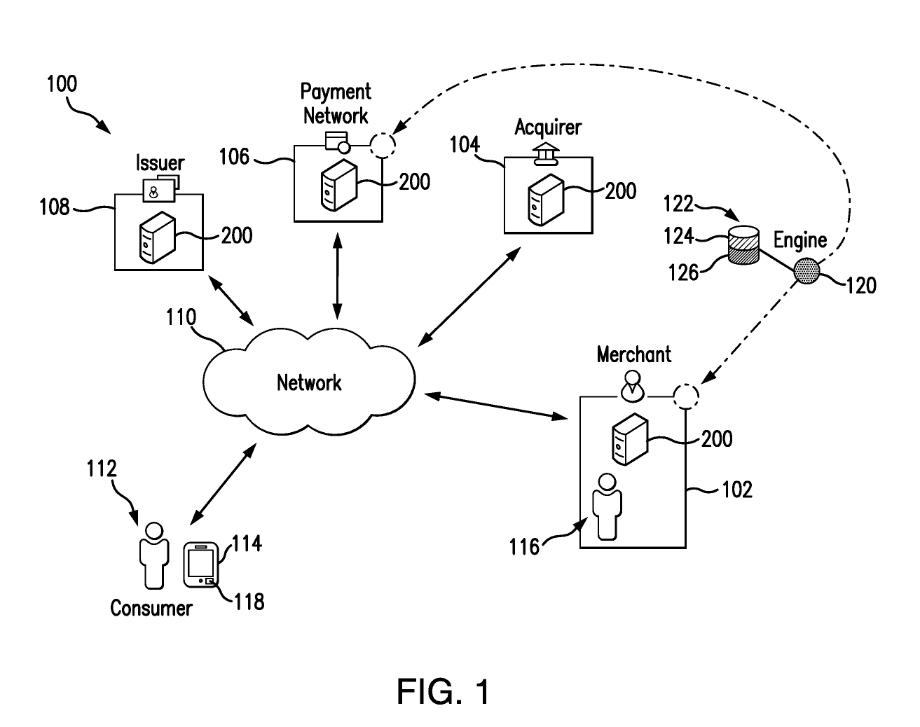

FIG. 1 illustrates an exemplary system 100, in which the one or more aspects of the present disclosure may be implemented. Although the system 100 is presented in one arrangement, other embodiments may include the parts of the system (or other parts) arranged otherwise depending on, for example, entities involved in processing purchase transactions to consumer payment accounts, interactions between consumers and merchants, manners of purchasing products by consumers, etc.

As shown in FIG. 1, the system 100 generally includes a merchant 102, an acquirer 104 associated with the merchant 102, a payment network 106, and an issuer 108 of payment accounts, each coupled to (and in communication with) network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 110 may include multiple different networks, such as a private payment transaction network made accessible by the payment network 106 to the acquirer 104 and the issuer 108 and, separately, the public Internet, which may provide interconnection between the merchant 102, the payment network 106, the issuer 108 and/or a consumer 112 (specifically, a communication device 114 associated with a consumer 112), etc.

The merchant 102 is generally associated with products (e.g., goods and/or services, etc.) offered for sale to consumers (e.g., the consumer 112, etc.). It should be appreciated that the merchant 102 may include any desired type of merchant, and that various types of merchants, large or small, single store or multi-store, permanent, mobile, and/or temporarily located, are within the scope of the present disclosure. For example, in one embodiment, the merchant 102 includes a kiosk disposed at a temporary location such as, for example, a shopping center. In another embodiment, the merchant 102 includes a vending cart located at a temporary location along a street or fair. In still another embodiment, the merchant 102 includes a department store permanently located at a brick-and-mortar building.

Regardless of the type and/or size, etc. of the merchant 102, the merchant 102 generally includes one or more merchant representatives, such as, for example merchant representative 116. The merchant representative 116 may include, without limitation, an employee, a sales associate, a cashier, a manager, an owner, etc. associated with the merchant 102. And, in the illustrated embodiment, the merchant representative 116 is present at the location of the merchant 102 to aid the consumer 112, for example, in shopping for products (e.g., to answer questions, to unlock displayed products, to retrieve stocked products, etc.) and/or in facilitating purchase transactions for the purchase of one or more products (e.g. including delivery of the purchased product(s) to the consumer 112, etc.).

Further, as shown in FIG. 1, the consumer 112 is associated with the communication device 114, which may include, for example, a tablet, a smartphone, a laptop, or another communication device, etc. The communication device 114 is generally, in this embodiment, a portable communication device. As shown, the communication device 114 includes an application 118, which is installed and active in the communication device 114 to thereby configure the communication device 114 (e.g., via computer-executable instructions, etc.) to operate as described herein. In various embodiments, the application 118 may include a payment application such as, for example, a virtual wallet (e.g., MasterPass®, Apple Pay®, Samsung Pay®, PayPal®, Google Wallet®, Android Wallet™, etc.), etc. Alternatively, the application 118 may be separate from any payment application, but still interact therewith, or not. With that said, when the communication device 114 is described as configured to perform various operations herein, it should be appreciated that it may be doing so generally in coordination with the application 118 (even if the application 118 is not specifically referenced).

While one merchant 102, one acquirer 104, one payment network 106, one issuer 108, one consumer 112, and one merchant representative 116 are illustrated in FIG. 1, it should be appreciated that any number of these parts (and their associated parts, including third parties) may be included in the system 100, or may be included as one or more parts of systems in other embodiments, consistent with the present disclosure. In fact, often multiple ones or even hundreds of one or more of these parts may be included in system embodiments of the present disclosure.

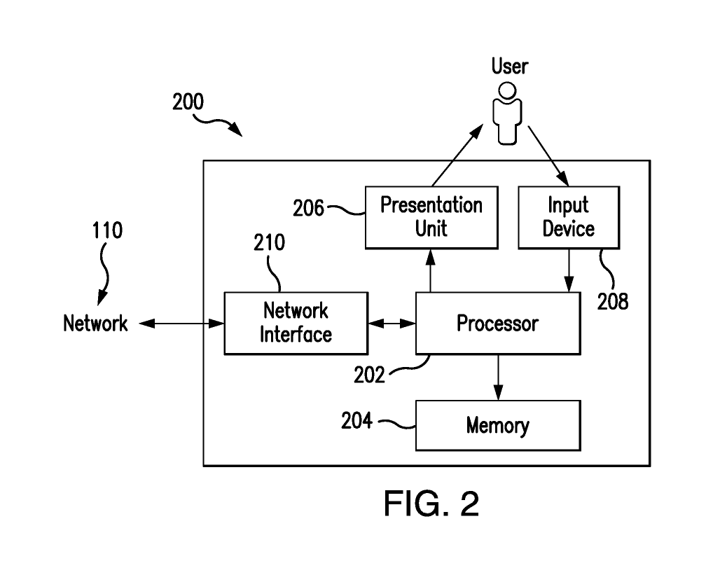

FIG. 2 illustrates an exemplary computing device 200 that can be used in the system 100. The computing device 200 may include, for example, one or more servers, workstations, personal computers, laptops, tablets, smartphones, PDAs, point-of-sale devices, etc. In addition, the computing device 200 may include a single computing device, or it may include multiple computing devices located in close proximity to or distributed over a geographic region, so long as the computing devices are specifically configured to operate as described herein. In the exemplary embodiment of FIG. 1, each of the merchant 102, the acquirer 104, the payment network 106, and the issuer 108 are illustrated as including, or being implemented in, computing device 200, coupled to the network 110. In addition, the communication device 114, which is associated with consumer 112, can also be considered a computing device consistent with computing device 200 for purposes of the description herein. However, the system 100 should not be considered to be limited to the computing device 200, as described below, as different computing devices and/or arrangements of computing devices may be used. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, merchant profiles, consumer profiles, payment account information, merchant catalogs, biometric data, interfaces and/or other types of data (and/or data structures) suitable for use as described herein. Furthermore, in various embodiments, computer-executable instructions may be stored in the memory 204 for execution by the processor 202 to cause the processor 202 to perform one or more of the operations described herein, such that the memory 204 is a physical, tangible, and non-transitory computer readable storage media. Such instructions often improve the efficiencies and/or performance of the processor 202 that is performing one or more of the various operations herein. It should be appreciated that the memory 204 may include a variety of different memories, each implemented in one or more of the operations described herein.

In the exemplary embodiment, the computing device 200 includes a presentation unit 206 that is coupled to (and is in communication with) the processor 202 (however, it should be appreciated that the computing device 200 could include output devices other than the presentation unit 206, etc.). The presentation unit 206 outputs information (e.g., merchant catalogs, merchant verifications, etc.), visually, for example, to a user of the computing device 200 such as to the consumer 112 in the system 100, the merchant representative 116, etc. It should be further appreciated that various interfaces (e.g., as defined by network-based applications, websites, etc.) may be displayed at computing device 200, and in particular at the presentation unit 206, to display certain information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

The computing device 200 also includes an input device 208 that receives inputs from the user of the computing device 200 (i.e., as user inputs) such as, for example, a captured biometric from the consumer 112 for the merchant representative 116, a selection of products from the merchant catalog, etc. The input device 208 is coupled to (and is in communication with) the processor 202 and may include, for example, a keyboard, a pointing device, a mouse, a stylus, a camera, a fingerprint scanner, a retina scanner, a palm scanner, a touch sensitive panel (e.g., a touch pad or a touch screen, etc.), another computing device, and/or an audio input device. Further, in various exemplary embodiments, a touch screen, such as that included in a tablet, a smartphone, or similar device, behaves as both a presentation unit and an input device.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 110. Further, in some exemplary embodiments, the computing device 200 includes the processor 202 and one or more network interfaces incorporated into or with the processor 202.

Referring again to FIG. 1, the system 100 also includes a verification engine 120, and a data structure 122 coupled to (and in communication with) the verification engine 120. The verification engine 120 is specifically configured, by executable instructions, to perform one or more of the operations herein. The verification engine 120 is illustrated in the system 100 as a standalone part and, as such, may be implemented in and/or associated with a computing device consistent with computing device 200 (with the data structure 122 included in memory 204 therein, or separate). However, as indicated by the dotted lines, the verification engine 120 may be incorporated, at least in part, with either the merchant 102 or the payment network 106 (e.g., in association with the computing devices 200 associated therewith, etc.). In addition, in still other embodiments, the verification engine 120 may be incorporated, at least partly, elsewhere in the system 100, or in other entities not shown.

In this exemplary embodiment, the data structure 122 includes two separate data structures: a merchant data structure 124 and a consumer data structure 126. In connection therewith, the data structure 122 (including the merchant data structure 124 and the consumer data structure 126) may be stored in memory (e.g., memory 204, etc.) incorporated in and/or in association with the verification engine 120, as indicated by the line in FIG. 1. However, in other embodiments, the data structure 122 may be stored in memory apart from the verification engine 120.

The merchant data structure 124, of the data structure 122, includes a profile for the merchant 102, and profiles for various other merchants that may desire to use features of the present disclosure. The merchant profile may include, for example, an identification of and related information for the principle owner(s) of the merchant 102 (e.g., name, contact information, etc.), as well as a listing of employees associated with the merchant 102, as well as various information related thereto (e.g., name, contact information, position with the merchant 102, etc.). In addition, the merchant profile may include location data for the merchant 102.

The profile for the merchant 102 also includes biometric data (e.g., reference biometrics, etc.) for the merchant representative 116 associated with the merchant 102, and for any other representative(s) of the merchant 102. The merchant data structure 124 may also include biometric data (e.g., as part of merchant profiles, etc.) for merchant representatives of other merchants associated with the system 100, but not shown. In connection therewith, the biometric data may include and/or relate to, without limitation, facial images, fingerprints, finger geometry recognition, palm prints, hand geometry recognition, hand dimensions (e.g., lengths of fingers, widths of hands, etc.), retina images, voice recordings, ear shapes, gait (e.g., walking style, etc.), heartbeats, etc.

Generally in the system 100, the biometric data (e.g., the reference biometric data, etc.) is received from the merchant representative 116 through registration of the merchant 102 (and/or the merchant representative 116) to the verification engine 120. In so doing, the verification engine 120 is configured to receive the biometric data from the merchant representative 116 (e.g., via an input of such biometric data to the computing device 200 associated with the merchant 102, etc.) and to store the biometric data in the merchant data structure 124, in association with the merchant 102. Such registration may be done at the initial registration of the merchant 102, and/or subsequently when the merchant representative 116 (and/or as new and/or additional merchant representatives) is/are hired and/or employed by the merchant 102, etc. Further, upon termination or other dis-association of the merchant representative 116 with the merchant 102, the verification engine 120 is configured to remove and/or delete his/her biometric data from the merchant data structure 124.

Also at registration of the merchant 102 to the verification engine 120, the verification engine 120 is configured to receive a merchant catalog from the merchant 102 and store the merchant catalog in the merchant data structure 124, in association with the merchant 102. The merchant catalog generally includes a listing of the products offered for sale by the merchant 102 and corresponding product identifiers therefor (e.g., stock keeping units (SKUs), etc.). The merchant catalog may also include, without limitation, product descriptions for the various products, images of the products, model numbers, prices, discounts, sales tax rates, and/or other relevant content related to the products.

Moreover, at registration of the merchant 102 to the verification engine 120, the merchant 102 may opt to have the verification engine 120 (or allow the verification engine 120 to) facilitate or aid in the facilitation of transactions for products selected for purchase by the consumer 112 (and other consumers). In connection therewith, during registration, the verification engine 120 is configured to also solicit contact information for the merchant 102, account information, and/or other relevant information related to processing transactions on behalf of the merchant 102 (e.g., information regarding the merchant's acquirer 104 such as an acquirer account number, etc.). The verification engine 120 is configured to then store the additional information in the data structure 122, and specifically in the merchant data structure 124.

With continued reference to FIG. 1, the consumer data structure 126, of the data structure 122, includes a profile for the consumer 112 (and profiles for various other consumers that may desire to use features of the present disclosure to help verify the merchant 102, or other registered merchants, prior to performing a transaction with the merchant 102). In particular, when the consumer 112 installs and/or activates the application 118 at the communication device 114 (or at a later time), the consumer 112 registers to the verification engine 120. In so doing, the verification engine 120 is configured to solicit various information relating to the consumer 112, such as his/her name, contact information (e.g., email address, phone number, etc.), application identifier, permissions, etc. through the application 118, or potentially through another computing device having access to the verification engine 120 (e.g., via a website, etc.). Upon receiving such information from the consumer 112, the verification engine 120 is configured to compile the profile for the consumer 112 (including an application identifier for the application 118, for example, at the consumer's communication device 114), and to store the consumer's profile in the consumer data structure 126.

In addition, when the application 118 includes a payment application (or is part of a payment application), the verification engine 120 may be configured to further solicit payment account information from the consumer 112 for his/her payment account (as issued to the consumer 112 by the issuer 108 in this embodiment), and to store the payment account information in the consumer's profile. In so doing, the verification engine 120 may be configured to additionally, or alternatively, coordinate with the payment network 106 and/or the issuer 108 to provision or have a payment account token (for the consumer's payment account) provisioned to the application 118 for use with the verification engine 120.

Once registered, the consumer 112 may proceed to shop among various registered merchants, including the merchant 102.

In the illustrated system 100, when shopping at the merchant 102, the consumer's shopping experience may include interactions with the merchant representative 116. When the consumer 112 is ready to make a purchase, the consumer 112 utilizes the communication device 114, via the application 118, to verify the representative 116. In particular, the communication device, via the application 118, is configured, in response to an input from the consumer 112, to capture biometric data from the merchant representative 116, for example, through input device 206 (e.g., a facial image of the merchant representative 116 through a camera input device 208, etc.). The communication device 114 is configured to then transmit the captured biometric data to the verification engine 120 (potentially, along with other data). In turn, the verification engine 120 is configured to search in the merchant data structure 124 for matching biometric data (e.g., for a matching reference biometric, etc.), to the biometric data received from the communication device 114. When a match is found, the verification engine 120 is configured to identify the merchant 102 as being associated with the matching biometric data (for the merchant representative 116) (broadly, as a trusted merchant, etc.), and to return a verification for the merchant representative 116 and/or to return the merchant catalog for the merchant 102 to the communication device 114.

Upon receipt of the merchant catalog from the verification engine 120, the communication device 114 is configured, via the application 118, to display the merchant catalog, or parts thereof, to the consumer 112 (e.g., via presentation unit 206, etc.). In so doing, the communication device 114 is configured to permit the consumer 112 to view details about certain products of interest, browse some or all products available for purchase from the merchant 102, and in some embodiments, identify a desired product in the merchant catalog for purchase.

In one example, upon identifying the product to purchase, the consumer 112 may facilitate a purchase transaction for the product directly with the merchant 102 (e.g., with the merchant representative 116, etc.). In so doing, the consumer 112 presents payment information to the merchant 102 for his/her payment account (as issued to the consumer 112 by the issuer 108) (e.g., via a payment device such as a credit card, a debit card, a prepaid card, a fob, the communication device 114 with a virtual wallet application active, etc.). As is traditional, the merchant 102 then transmits an authorization request for the transaction (comprising transaction data for the transaction) to the acquirer 104 (through the network 110). In turn, the acquirer 104 communicates the authorization request with the issuer 108 (again via the network 110) through the payment network 106 (e.g., through MasterCard®, VISA®, Discover®, American Express®, etc.). The issuer 108 determines whether the consumer's payment account is in good standing and whether there are sufficient funds and/or credit to fund the transaction. If approved, an authorization reply, or response (indicating the approval of the transaction), is transmitted back from the issuer 108 to the merchant 102, thereby permitting the merchant 102 to complete the transaction. The transaction is later cleared and/or settled (via appropriate transaction messages such as clearing messages and/or settlement messages, for example) by and between the merchant 102, the acquirer 104, and the issuer 108 (by appropriate agreements).

In another example, the communication device 114 is configured to receive a selection from the consumer 112 for the product for purchase in the merchant catalog and to communicate a purchase request to the verification engine 120. In turn, the verification engine 120 is configured to interact with the acquirer 104, the payment network 106, and/or the issuer 108, as appropriate, to facilitate a purchase transaction for the product.

In this example, the verification engine 120 is configured to initially retrieve the payment account information for the consumer's payment account from the consumer's profile in the data structure 122. Alternatively, the verification engine 120 may be configured to solicit the payment account information from the consumer 112 (e.g., the provisioned token in the communication device 114, etc.). The verification engine 120 is configured to then generate and to transmit an authorization request for the transaction to the issuer 108. Depending on the location and/or association of the verification engine 120 in the system 100, the verification engine 120 may be configured to transmit the authorization request directly to the issuer 108. Or, the verification engine 120 may be configured to transmit the authorization request to the merchant's acquirer 104, who then communicates the authorization request to the issuer 108, through the payment network 106. In either case, the issuer 108 determines whether the consumer's payment account is in good standing and whether there is sufficient credit and/or funds to complete the transaction. If the issuer 108 accepts the transaction, a reply authorizing the transaction is provided back to the verification engine 120 (e.g., directly, or through the payment network 106 and the acquirer 104; etc.), thereby permitting the verification engine 120 to complete the transaction. The transaction is later cleared and/or settled by and between the merchant 102 and the acquirer 104 (via an agreement between the merchant 102 and the acquirer 104), and by and between the acquirer 104 and the issuer 108 (via an agreement between the acquirer 104 and the issuer 108) (through further communication therebetween). If the issuer 108 declines the transaction, however, the authorization reply is transmit back to the verification engine 120 (as described above), whereupon the transaction is halted.

When the verification engine 120 transmits the authorization request for the transaction directly to the issuer 108, and receives a reply directly from the issuer 108, the verification engine 120 may be configured to corresponding transmit notifications to the acquirer 104 indicative of the transaction. In so doing, the acquirer 104 is aware of the transaction, for example, for purposes of later clearing and/or settling, etc.

Then in this example, once the transaction for the product is authorized, the verification engine 120 is configured to return a purchase confirmation to the consumer 112 (e.g., via the application 118, etc.) and/or to the merchant 102 (e.g., at the computing device 200). The purchase confirmation may include various information regarding the purchase transaction, for example, an indication of the product purchased by the consumer 112 and a confirmation code for the purchase, etc. Based on the purchase confirmation, be it at the consumer's communication device 114 or at the computing device 200 associated with the merchant 102, the merchant representative 116 can verify that the product has been purchased (e.g., via the confirmation code, etc.) and can deliver the appropriate product to the consumer 112 (e.g., permit the consumer 112 to leave the merchant location with the product(s), physically hand the product(s) over to the consumer 112, direct the product(s) to be transported to a location of the consumer's choosing, etc.)

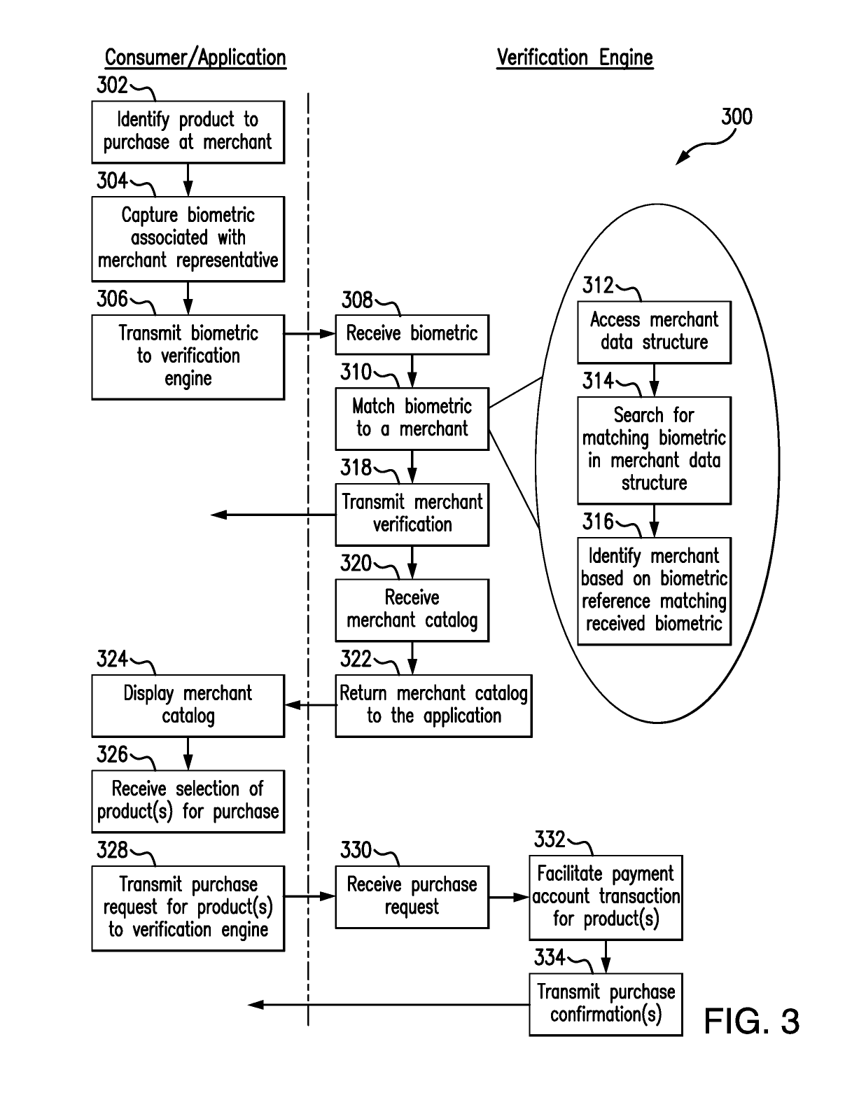

FIG. 3 illustrates an exemplary method 300 for facilitating a payment account transaction with a trusted merchant. The exemplary method 300 is described as implemented in the verification engine 120 of system 100, in association with the communication device 114 and the application 118. However, it should be understood that the method 300 is not limited to this configuration, as the method 300 may be implemented in other parts of the system 100. As such, the methods herein should not be understood to be limited to the exemplary system 100 or the exemplary computing device 200, and likewise, the systems and the computing devices herein should not be understood to be limited to the exemplary method 300.

As shown in FIG. 3, in the exemplary method 300, in connection with a shopping experience by the consumer 112 at the merchant 102 (e.g., at a kiosk associated with the merchant 102, etc.), the consumer 112 initially identifies a product or multiple products for purchase at the merchant 102, at 302 (independently, or through interaction with the merchant representative 116). The consumer 112 then accesses his/her communication device 114 and, in particular, the application 118, to verify the merchant 102, and specifically, the merchant representative 116.

In connection therewith, the application 118 prompts the consumer 112 to capture a biometric from the merchant representative 116. And, the consumer 112 situates the communication device 114 to do so (e.g., points the camera input device 208 at the merchant representative 116, etc.) and then captures the biometric, at 304, using his/her communication device 114 (via the application 118). For example, the consumer 112 may capture a facial image (broadly, a biometric) of the merchant representative 116. The captured image may or may not be stored in memory 204 of the communication device 114. It should be appreciated that the consumer may capture (via the communication device 114) other biometrics from the merchant representative 116 within the scope of the present disclosure including, without limitation, those listed above, etc. In any case, once captured, the biometric is transmitted, by the application 118 and/or the communication device 114, to the verification engine 120, at 306. In turn, the verification engine 120 receives the biometric from the application 118 and/or communication device 114, at 308.

Next, the verification engine 120 searches in the data structure 122 for a matching reference biometric, at 310. In particular in the exemplary method 300, the verification engine 120 accesses the merchant data structure 124 (of the data structure 122), at 312, and searches for the received/sample biometric in the merchant data structure 124, at 314. In so doing, the verification engine compares the received biometric to the reference biometrics included in the merchant data structure 124 until a match is found.

The comparison of the received biometric to the reference biometrics included in the merchant data structure 124 (as part of the search at 314) may be done via any suitable algorithms, for example, depending on the particular biometric being compared (e.g., utilizing biometric feature extraction and template generation and comparison (where the templates represent the biometrics reduced to zeros and ones, as is generally known, with the comparison then involving a string comparison thereof), etc.). What's more, the comparison may require an exact match, or the comparison may require a match within an acceptable confidence range (e.g., depending on the algorithm, depending on the particular biometric, etc.). In particular, for example, principal components analysis (PCA), linear discriminant analysis (LDA), elastic bunch graph matching (EBGM), independent component analysis (ICA), evolutionary pursuit (EP), kernel methods, the trance transform, an active appearance model (AAM), a 3-D morphable model, 3-D face recognition, the Bayesian framework, hidden Markov Models (HMMs), the GaussianFace face recognition algorithm, FaceNet, etc. may be used to compare facial images; minutiae-based matching, pattern matching, etc. may be used to compare fingerprints; IrisCode® comparison may be used to compare retina scans; minutiae-based matching, correlation-based matching, ridge-based matching, etc. may be used to compare palm prints; etc.

In some embodiments, prior to searching for the received biometric in the merchant data structure 124, the verification engine 120 may initially (as an option) search in the merchant data structure 124 for the merchant 102, based on one or more various attributes associated with the merchant 102 (to potentially limit the scope of the biometric search). Such attributes may include, for example, a merchant ID associated with the merchant 102 as received from the application 118, a merchant name (e.g., a doing-business-as (DBA) name, etc.), a tax ID, etc. In addition, in some embodiments, prior to searching for the received biometric in the merchant data structure 124, the verification engine 120 may initially (as an option) search in the merchant data structure 124 for the merchant 102, based on a present location of the consumer 112, as determined by the consumer's communication device 114 (and made available to the verification engine 120 by the application 118), to potentially limit the scope of the biometric search. Then, upon narrowing the biometric search to the particular merchant 102, the verification engine 120 searches, at 314, among the reference biometrics in the merchant data structure 124 associated with the particular merchant 102.

In any case, when the verification engine 120 finds a matching reference biometric in the merchant data structure 124 (within applicable standards, for example), the verification engine 120 identifies the merchant 102, and potentially the merchant representative 116, at 316, associated with the received biometric. And, at 318, the verification engine 120 transmits a merchant verification to the consumer 112, via the consumer's communication device 114 (e.g., via an email, a short message service (SMS) text, etc.) and/or the application 118 associated therewith. The merchant verification provides an indication to the consumer 112 that the merchant representative 116 has been verified as being associated with the merchant (and is a trusted merchant representative) and/or that the merchant is a trusted merchant, as used herein. Alternatively, when the verification engine 120 does not find a matching reference biometric in the merchant data structure 124 for the merchant 102, the verification engine 120 may transmit a warning message to the consumer 112 (e.g., indicating the representative 116 is not found, or is not trusted; etc.) and/or to the merchant 102.

In addition, in the exemplary embodiment of FIG. 3, at 320, the verification engine 120 retrieves a merchant catalog associated with the identified merchant 102 (e.g., as provided by the merchant 102 during registration to the verification engine 120, etc.), from the merchant data structure 124. The verification engine 120 then transmits the merchant catalog to the consumer 112 at the communication device 114, at 322, via the application 118. As described above, the merchant catalog generally includes a listing of the products offered for sale by the merchant 102 and corresponding product identifiers therefor (e.g., SKUs, etc.). The merchant catalog may also include, without limitation, product descriptions for the various products, images of the products, model numbers, prices, discounts, sales tax rates, and/or other relevant content related to the products.

Upon receiving the merchant catalog, the communication device 114 displays the merchant catalog to the consumer 112, at 324, through the application 118 and via presentation unit 206. The consumer 112 may then be permitted to browse among the products in the merchant catalog to identify the particular product desired for purchase (as identified at 302, or other products), and/or the communication device 114 may allow the consumer 112 to search in the merchant catalog for the particular product (or other products). It should be appreciated that the merchant catalog may be displayed by the communication device 114 in a variety of manners, with certain information about each product in the catalog (e.g., description, price, images, etc.) being presented to the consumer 112. For example, the communication device 114 may display multiple images of products to the consumer 112, as included in the merchant catalog, where the consumer 112 can then select one of the images (via input device 208) to view additional information about the product. Or, the communication device 114 may display categories of products to the consumer 112, where the consumer 112 can then initially select a category to view related products.

Once the desired product (or products) to be purchased from the merchant 102 is (are) identified in the product catalog (or otherwise identified), the consumer 112, via an interface at the communication device 114, as defined by the application 118, may select the product for purchase (using input device 208). And, at 326, the communication device 114, via the application 118, receives the selection of the product (or products). It should be appreciated that the product selected by the consumer 112 for purchase may include, as described above, the product initially identified by the consumer 112 at the merchant 102 when the consumer initiated the current shopping experience at 302. Alternatively, or additionally, the product selected by the consumer 112 may include a different product included in the merchant catalog, or an additional product to the initially identified product.

In connection with the selected product, the communication device 114 then transmits a purchase request to the verification engine 120, at 328. This may automatically be done, by the communication device 114 (or the application 118) upon selection of the product by the consumer 112. Or, following the product selection, the communication device 114 may solicit the request from the consumer 112 via the interface described above (or via another interface). Further, in some embodiments, the communication device 114 (via the application 118) may solicit payment account information for the consumer's payment account, for use in funding the purchase transaction for the product (however, as described herein, this is not required in all embodiments). In any case, the verification engine 120 then receives the purchase request from the communication device 114, at 330.

The purchase request includes various information about the product selected by the consumer 112 at 326. For example, the purchase request may include a product description for the selected product, a SKU for the selected product, and a product price (including tax), and payment account credentials for the consumer's payment account. In addition, in some embodiments, the purchase request may include the payment account credentials for the consumer's payment account to be used in the purchase transaction, as solicited from the consumer 112 (again, however, this is not required in all embodiments).

Then in the method 300, upon receipt of the purchase request, the verification engine 120 facilitates a purchase transaction for the selected product, at 332. In so doing in this embodiment, the verification engine 120 generates an authorization request for the purchase transaction based on the information included in the purchase request. In addition, the verification engine 120 accesses the consumer data structure 126, and in particular the consumer profile for the consumer 112, and retrieves information therefrom for use in the authorization request (including payment account credentials for the consumer's payment account when not included in the purchase request). In turn, the verification engine 120 transmits the authorization request for the transaction to the issuer 108, via the acquirer 104 and the payment network 106, as described above in the system 100.

Upon receipt of an authorization reply from the issuer 108 indicating approval of the purchase transaction, the verification engine 120 transmits an authorization message to the acquirer 104 to help facilitate later settlement and clearing of the transaction (e.g., deposit of funds to an account associated with the merchant 102). The verification engine 120 also transmits, at 334, a purchase confirmation to the consumer 112 at the communication device 114 (and specifically, at the application 118). The application 118 may, in turn, display the confirmation to the consumer 112, who may then show the confirmation to the merchant representative 116. For example, the confirmation may include a barcode or QR code displayed at the communication device 114, to be scanned or otherwise recognized by the merchant 102 (e.g., by computing evidence 220, etc.). Upon viewing the confirmation, the merchant representative 116 may deliver the selected product to the consumer 112, for example, by handing the product to the consumer 112, directing the product to be routed to the consumer's location or address, or even allowing the consumer 112 take possession of the product himself/herself, etc. In addition, or alternatively, the verification engine 120 may transmit a purchase confirmation of the authorized transaction to the merchant 102 and/or the merchant representative 116, which would permit the merchant representative to release the product(s) to the consumer 112 as described above.

In the above embodiment, the consumer 112 is permitted to purchase the selected product via the verification engine 120. It should be appreciated, however, that in one or more other embodiments, the verification engine 120 may simply transmit the merchant verification to the consumer 112, at 318, whereby the consumer 112 can then complete the purchase transaction for the desired product (as identified by the consumer 112 at 302) directly with the merchant 102. For example, the consumer 112 can provide a payment device directly to the merchant 102 to facilitate the purchase transaction for the product using the consumer's payment account (as described above in the system 100). As such, through the merchant verification, the consumer 112 may more comfortably proceed with the purchase of the product at the merchant 102 and/or presentation of payment account credentials directly to the merchant 102 (and the merchant representative 116) to purchase the product, apart from the application 118 and/or the verification engine 120.

In view of the above, the systems and methods herein may permit a consumer to verify a merchant, and specifically a merchant representative, prior to transacting with the merchant for the purchase of products. Once verified, the merchant and/or merchant representative is/are a “trusted” merchant (and/or merchant representative), whereby the consumer is able to present payment account credentials, or rely on the systems and/or methods herein, to facilitate the purchase transaction for the product, funded by the consumer's payment account. In this manner, the consumer is able to interact with the merchant, who may be, for example, unknown or unfamiliar to the consumer, or a smaller, less perceivably stable merchant, without concern that the merchant (or the associated merchant representative) is not who he/she claims to be. In addition, when the merchant is registered herein, the consumer is further able to have increased confidence in the products offered for sale by the merchant.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving a biometric from a consumer; (b) matching the biometric to a merchant included in a data structure, the merchant associated with a product catalog including at least one product offered for sale by the merchant; (c) returning, in response to the biometric, the product catalog associated with the merchant to the consumer; (d) receiving a selection of the at least one product from the consumer; (e) facilitating a purchase transaction for the at least one product; (f) transmitting a transaction confirmation for the purchase transaction to the consumer and/or the merchant, whereby the merchant is able to confirm the purchase transaction via the transaction confirmation and deliver the at least one product to the consumer; and (g) transmitting a merchant verification for the merchant to the consumer, when the biometric is matched to the merchant in the data structure.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in facilitating payment account transactions, the method comprising:
receiving, at a computing device, a biometric from a consumer;
matching, by the computing device, the biometric to a merchant included in a data structure, the merchant associated with a product catalog including at least one product offered for sale by the merchant;
returning, by the computing device, in response to the biometric, the product catalog associated with the merchant to the consumer;
receiving a selection of the at least one product from the consumer;
facilitating a purchase transaction for the at least one product; and
transmitting, by the computing device, a transaction confirmation for the purchase transaction to the consumer and/or the merchant, whereby the merchant is able to confirm the purchase transaction via the transaction confirmation and deliver the at least one product to the consumer.

2. The computer-implemented method of claim 1, wherein the biometric includes an image of a face of a representative of the merchant; and
wherein matching the biometric to the merchant includes matching the image to a reference image in the data structure associated with the representative of the merchant.

3. The computer-implemented method of claim 2, further comprising storing the reference image associated with the representative of the merchant in the data structure.

4. The computer-implemented method of claim 1, further comprising transmitting, by the computing device, a merchant verification for the merchant to the consumer, when the biometric is matched to the merchant in the data structure.

5. The computer-implemented method of claim 4, further comprising returning, by the computing device, a warning message when the biometric is not matched to a merchant in the data structure.

6. The computer-implemented method of claim 1, wherein the product catalog includes content related to the at least one product, the content including an identifier unique to the at least one product and a description of the at least one product.

7. The computer-implemented method of claim 6, wherein the identifier includes a stock keeping unit (SKU) for the at least one product.

8. The computer-implemented method of claim 1, wherein facilitating a purchase transaction for the at least one product includes:
retrieving payment account credentials for a payment account associated with the consumer from data structure; and
appending the payment account credentials to an authorization request for the purchase transaction.

9. The computer-implemented method of claim 1, wherein facilitating a purchase transaction for the at least one product includes:
receiving payment account credentials for a payment account associated with the consumer from the consumer; and
appending the payment account credentials to an authorization request for the purchase transaction.

10. A system for use in facilitating payment account transactions with a merchant, the system comprising:
a memory including a merchant data structure, the merchant data structure including a merchant profile having at least one reference biometric and at least one product offered for sale by a merchant; and
a verification engine coupled to the memory and configured to:
receive a captured biometric from a consumer;
search in the merchant data structure for a reference biometric based on the captured biometric; and
when the captured biometric matches the at least one reference biometric in the memory for the merchant, return the at least one product included in the merchant profile to the consumer, thereby permitting the consumer to view the at least one product for the merchant based on the matching captured biometric associated with the merchant.

11. The system of claim 10, wherein the verification engine is further configured to:
receive, from the consumer, a selection of the at least one product;
facilitate a payment account transaction for the at least one product; and
transmit a confirmation of the payment account transaction to the merchant and/or the consumer, whereby the merchant is able to deliver the at least one product to the consumer.

12. The system of claim 11, wherein the memory further includes a consumer data structure, the consumer data structure including a consumer profile having contact information for the consumer and payment account credentials for a payment account associated with the consumer; and
wherein the verification engine is further configured to:
identify the consumer profile associated with the consumer, in response to receiving the selection of the at least one product from the consumer; and
facilitate the payment account transaction based on the payment account credentials included in the consumer profile for the consumer.

13. The system of claim 12 wherein the biometric includes an image of a face of a representative of the merchant.

14. The system of claim 11, wherein the verification engine is configured to receive payment account credentials from the consumer via a virtual wallet, and facilitate the payment account transaction based on the payment account credentials received from the consumer.

15. The system of claim 11, wherein, in connection with facilitating the payment account transaction for the at least one product, the verification engine is configured to transmit an authorization request for the payment account transaction to an issuer associated with the consumer's payment account.

16. A non-transitory computer readable storage media including computer-executable instructions for use in facilitating payment account transactions with a merchant, which when executed by a processor, cause the processor to:
receive, from a consumer, a biometric associated with a merchant;
search in a data structure for the biometric;
transmit a merchant verification for the merchant to the consumer, when the biometric associated with the merchant is in the data structure, whereby the consumer is allowed to proceed with a purchase transaction for one or more products at the merchant.

17. The non-transitory computer readable storage media of claim 16, wherein the computer-executable instructions, when executed by the processor, further cause the processor to:
receive, from the consumer, a purchase request for the one or more products; and
facilitate a purchase transaction for the one or more products.

18. The non-transitory computer readable storage media of claim 17, wherein the computer-executable instructions, when executed by the processor, further cause the processor to transmit a transaction confirmation for the purchase transaction to the consumer and/or the merchant, whereby the merchant is able to confirm the purchase transaction via the transaction confirmation and deliver the one or more products to the consumer.

19. The non-transitory computer readable storage media of claim 18, wherein the computer-executable instructions, when executed by the processor, further cause the processor to identify a payment account associated with the consumer and facilitate the purchase transaction based on the payment account.

20. The non-transitory computer readable storage media of claim 18, wherein the payment account is associated with a virtual wallet; and
wherein the computer-executable instructions, when executed by the processor, further cause the processor to receive payment account credentials for the payment account from the virtual wallet and facilitate the purchase transaction based on the received payment account credentials.
